(19) United States
(12) Patent Application Publication
(10) Pub. No.: US 2024/0143320 A1
(43) Pub. Date: May 2, 2024

(54) CLUSTERING OF DATA PLANES ON A CONTROL PLANE

(71) Applicant: KONG INC., San Francisco, CA (US)

(72) Inventors: Datong Sun, Shanghai (CN); Aapo Talvensaari, Vantaa (FI); Harry Bagdi, Seattle, WA (US); Xumin Zhou, Shanghai (CN); Chrono Luo, Shanghai (CN); Wangchong Zhou, Shanghai (CN); Javier Guerra, London (GB)

(21) Appl. No.: 18/050,004

(22) Filed: Oct. 26, 2022

(51) Int. Cl. G06F 8/71; G06F 9/50; H04L 67/51

(52) U.S. Cl. CPC G06F 8/71; G06F 9/5077; H04L 67/51; G06F 2209/505

(57) ABSTRACT

Disclosed embodiments are directed at systems, methods, and architecture for configuring data planes based on clusters of nodes. A control plane links a plurality of microservices for a microservice architecture application. Each microservice includes a data plane that serves traffic for the microservice from the control plane and is processed at a node of a plurality of nodes. The control plane links a subset of the plurality of nodes in a cluster, such that the cluster is associated with a related set of microservices and data planes. The control plane updates configurations of nodes in the cluster to a latest configuration. The control plane sends the latest configuration to each data plane of the cluster. Each data plane of the cluster caches the latest configuration on a local storage disk of an associated node.

### TECHNICAL FIELD

The disclosure relates to distributed microservice architecture networks and more particularly to using clustering data planes at a control plane.

### BACKGROUND

Microservices are a software development technique—a variant of the service-oriented architecture (SOA) architectural style that structures an application as a collection of loosely coupled services (embodied in application program interfaces). In a microservices architecture, services are fine-grained and the protocols are lightweight. The benefit of decomposing an application into different smaller services is that it improves modularity. This makes the application easier to understand, develop, test, and become more resilient to architecture erosion. Microservices parallelize development by enabling small autonomous teams to develop, deploy and scale their respective services independently. Microservice-based architectures enable continuous delivery and deployment.

A system may monitor a plurality of microservices to ensure proper processing of data for applications running via the microservices. Traditionally, the system requires a database to store configured entities used by the microservices, such as routes, services, and plugins. However, using an external database may increase latency for the system when need for accessing stored data arises. Further, if the system loses connection to the database, the system would not be able to use the latest configuration of the configured entities stored at the database, thus affecting the processes running at the microservices, which may be slowed or stopped without access to the database.

### BRIEF DESCRIPTION OF THE DRAWINGS

FIG. 1A illustrates a prior art approach with multiple APIs having functionalities common to one another.

FIG. 1B illustrates a distributed API gateway architecture, according to an embodiment of the disclosed technology.

FIG. 2 illustrates a block diagram of an example environment suitable for functionalities provided by a gateway node, according to an embodiment of the disclosed technology.

FIG. 3A illustrates a block diagram of an example environment with a cluster of gateway nodes in operation, according to an embodiment of the disclosed technology.

FIG. 3B illustrates a schematic of a data store shared by multiple gateway nodes, according to an embodiment of the disclosed technology.

FIG. 4A and FIG. 4B illustrate example ports and connections of a gateway node, according to an embodiment of the disclosed technology.

FIG. 5 illustrates a flow diagram showing steps involved in the installation of a plugin at a gateway node, according to an embodiment of the disclosed technology.

FIG. 6 illustrates a sequence diagram showing components and associated steps involved in loading configurations and code at runtime, according to an embodiment of the disclosed technology.

FIG. 7 is a block diagram of a control plane system for a service mesh in a microservices architecture

FIG. 8 is a block diagram illustrating service groups and features associated with identification thereof.

FIG. 9 is a block diagram illustrating an example environment of a control plane and clusters of nodes.

FIG. 10 is a flowchart illustrating a process for sending a latest configuration to data planes associated with a cluster.

FIG. 11 is a flowchart illustrating a process for accessing a configuration to serve a microservice.

FIG. 12 depicts a diagrammatic representation of a machine in the example form of a computer system within a set of instructions, causing the machine to perform any one or more of the methodologies discussed herein, to be executed.

### DETAILED DESCRIPTION

The disclosed technology describes how a control plane links sets of nodes into clusters. In network routing, the control plane is the part of the router architecture that is concerned with drawing the network topology, or the routing table that defines what to do with incoming packets. Control plane logic also can define certain packets to be discarded, as well as preferential treatment of certain packets for which a high quality of service is defined by such mechanisms as differentiated services.

In monolithic application architecture, a control plane operates outside the core application. In a microservices architecture, the control plane operates between each microservice (in some embodiments, an application programming interface or “API”) that makes up the microservice architecture. Proxies are linked to each microservice. The proxy attached to each microservice is referred to as a “data plane proxy,” Or simply, a “data plane.” Examples of data plane proxies include the sidecar proxies of Envoy proxies. The data plane proxies and associated microservices run at one or more nodes (e.g., processors) that may be distributed around the globe. The control plane monitors the operations of the microservices based on output data received from the microservices. The control plane communicates settings and input data with the microservices via the data plane proxies to run one or more microservice architecture applications.

The control plane determines a subset of microservices operating for a microservice architecture application and links a set of nodes running the microservices and their associated data plane proxies together into a cluster. The control plane updates configurations of the nodes in the cluster for the microservice architecture application and sends the latest configuration to the associated data plane proxies such that the data plane proxies each cache the latest configuration on a local storage disk.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure are directed at systems, methods, and architecture for management and configuration of microservices that together comprise one or more applications. The architecture is a distributed plurality of microservices that each perform processes for the applications. The plurality of microservices are connected at a control plane that monitors the output data from the microservices for running the applications. At the request of a client, the control plane configures microservices with event hooks, such that when a particular event occurs at a particular source, a configured microservice runs a particular handler. The control thus employs the event hooks to automatically take action when events occur in at a microservice, client, or external application.

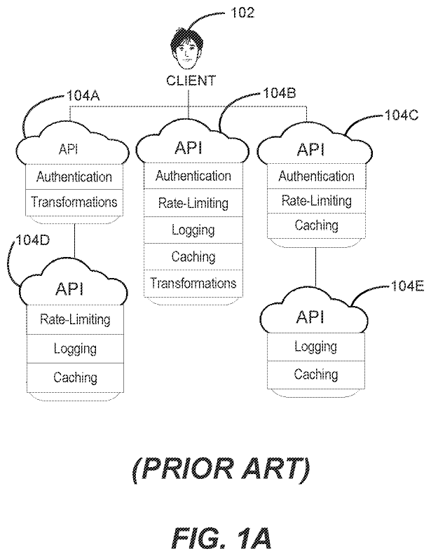

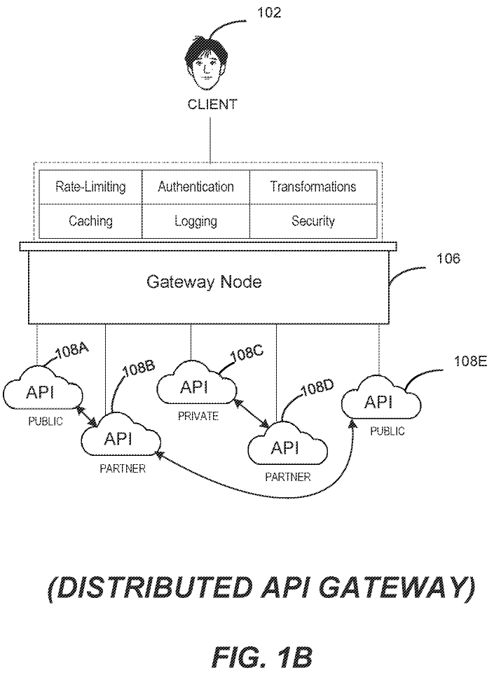

FIG. 1A illustrates a prior art approach with multiple APIs having functionalities common to one another. As shown in FIG. 1A, a client 102 is associated with APIs 104A, 104B, 104C, 104D, and 104E. Each API has a standard set of features or functionalities associated with it. For example, the standard set of functionalities associated with API 104A are “authentication” and “transformations.” The standard set of functionalities associated with API 104B are “authentication,” “rate-limiting,” “logging,” “caching,” and “transformations.” Thus, “authentication” and “transformations” are functionalities that are common to APIs 104A and 104B. Similarly, several other APIs in FIG. 1A share common functionalities. However, it is noted that having each API handle its own functionalities individually causes duplication of efforts and code associated with these functionalities, which is inefficient. This problem becomes significantly more challenging when there are tens of thousands of APIs and millions of clients requesting API-related services per day.

FIG. 1B illustrates a distributed API gateway architecture according to an embodiment of the disclosed technology. To address the challenge described in connection with FIG. 1A, the disclosed technology provides a distributed API gateway architecture as shown in FIG. 1B. Specifically, disclosed embodiments implement common API functionalities by bundling the common API functionalities into a gateway node 106 (also referred to herein as an API Gateway). Gateway node 106 implements common functionalities as a core set of functionalities that runs in front of APIs 108A, 108B, 108C, 108D, and 108E. The core set of functionalities include rate limiting, caching, authentication, logging, transformations, and security. It will be understood that the above-mentioned core set of functionalities are for examples and illustrations. There can be other functionalities included in the core set of functionalities besides those discussed in FIG. 1B. In some applications, gateway node 106 can help launch large-scale deployments in a very short time at reduced complexity and is therefore an inexpensive replacement for expensive proprietary API management systems. The disclosed technology includes a distributed architecture of gateway nodes with each gateway node bundled with a set of functionalities that can be extended depending on the use-case or applications.

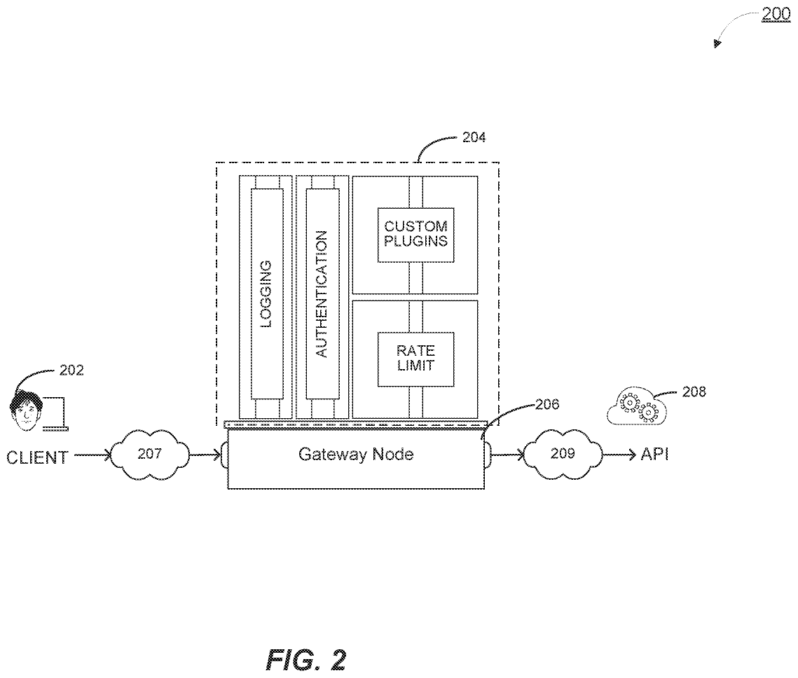

FIG. 2 illustrates a block diagram of an example environment suitable for functionalities provided by a gateway node according to an embodiment of the disclosed technology. In some embodiments, a core set of functionalities are provided in the form of “plugins” or “add-ons” installed at a gateway node. (Generally, a plugin is a component that allows modification of what a system can do usually without forcing a redesign/compile of the system. When an application supports plug-ins, it enables customization. The common examples are the plug-ins used in web browsers to add new features such as search-engines, virus scanners, or the ability to utilize a new file type such as a new video format.)

As an example, a set of plugins 204 shown in FIG. 2 are provided by gateway node 206 positioned between a client 202 and one or more HTTP APIs. Electronic devices operated by client 202 can include, but are not limited to, a server desktop, a desktop computer, a computer cluster, a mobile computing device such as a notebook, a laptop computer, a handheld computer, a mobile phone, a smart phone, a PDA, and/or an iPhone or Droid device, etc. Gateway node 206 and client 202 are configured to communicate with each other via network 207. Gateway node 206 and one or more APIs 208 are configured to communicate with each other via network 209. In some embodiments, the one or more APIs reside in one or more API servers, API data stores, or one or more API hubs. Various combinations of configurations are possible.

Networks 207 and 209 can be any collection of distinct networks operating wholly or partially in conjunction to provide connectivity to/from client 202 and one or more APIs 208. In one embodiment, network communications can be achieved by, an open network, such as the Internet, or a private network, such as an intranet and/or the extranet. Networks 207 and 209 can be a telephonic network, an open network, such as the Internet, or a private network, such as an intranet and/or the extranet. For example, the Internet can provide file transfer, remote login, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

Client 202 and one or more APIs 208 can be coupled to the network 150 (e.g., Internet) via a dial-up connection, a digital subscriber loop (DSL, ADSL), cable modem, wireless connections, and/or other types of connection. Thus, the client devices 102A-N, 112A-N, and 122A-N can communicate with remote servers (e.g., API servers 130A-N, hub servers, mail servers, instant messaging servers, etc.) that provide access to user interfaces of the World Wide Web via a web browser, for example.

The set of plugins 204 include authentication, logging, rate-limiting, and custom plugins, of which authentication, logging, traffic control, rate-limiting can be considered as the core set of functionalities. An authentication functionality can allow an authentication plugin to check for valid login credentials such as usernames and passwords. A logging functionality of a logging plugin logs data associated with requests and responses. A traffic control functionality of a traffic control plugin manages, throttles, and restricts inbound and outbound API traffic. A rate limiting functionality can allow managing, throttling, and restricting inbound and outbound API traffic. For example, a rate limiting plugin can determine how many HTTP requests a developer can make in a given period of seconds, minutes, hours, days, months or years.

A plugin can be regarded as a piece of stand-alone code. After a plugin is installed at a gateway node, it is available to be used. For example, gateway node 206 can execute a plugin in between an API-related request and providing an associated response to the API-related request. One advantage of the disclosed system is that the system can be expanded by adding new plugins. In some embodiments, gateway node 206 can expand the core set of functionalities by providing custom plugins. Custom plugins can be provided by the entity that operates the cluster of gateway nodes. In some instances, custom plugins are developed (e.g., built from “scratch”) by developers or any user of the disclosed system. It can be appreciated that plugins, used in accordance with the disclosed technology, facilitate in centralizing one or more common functionalities that would be otherwise distributed across the APIs, making it harder to build, scale and maintain the APIs.

Other examples of plugins can be a security plugin, a monitoring and analytics plugin, and a transformation plugin. A security functionality can be associated with the system restricting access to an API by whitelisting or blacklisting/whitelisting one or more consumers identified, for example, in one or more Access Control Lists (ACLs). In some embodiments, the security plugin requires an authentication plugin to be enabled on an API. In some use cases, a request sent by a client can be transformed or altered before being sent to an API. A transformation plugin can apply a transformations functionality to alter the request sent by a client. In many use cases, a client might wish to monitor request and response data. A monitoring and analytics plugin can allow monitoring, visualizing, and inspecting APIs and microservices traffic.

In some embodiments, a plugin is Lua code that is executed during the life-cycle of a proxied request and response. Through plugins, functionalities of a gateway node can be extended to fit any custom need or integration challenge. For example, if a consumer of the disclosed system needs to integrate their API's user authentication with a third-party enterprise security system, it can be implemented in the form of a dedicated (custom) plugin that is run on every request targeting that given API. One advantage, among others, of the disclosed system is that the distributed cluster of gateway nodes is scalable by simply adding more nodes, implying that the system can handle virtually any load while keeping latency low.

One advantage of the disclosed system is that it is platform agnostic, which implies that the system can run anywhere. In one implementation, the distributed cluster can be deployed in multiple data centers of an organization. In some implementations, the distributed cluster can be deployed as multiple nodes in a cloud environment. In some implementations, the distributed cluster can be deployed as a hybrid setup involving physical and cloud computers. In some other implementations, the distributed cluster can be deployed as containers.

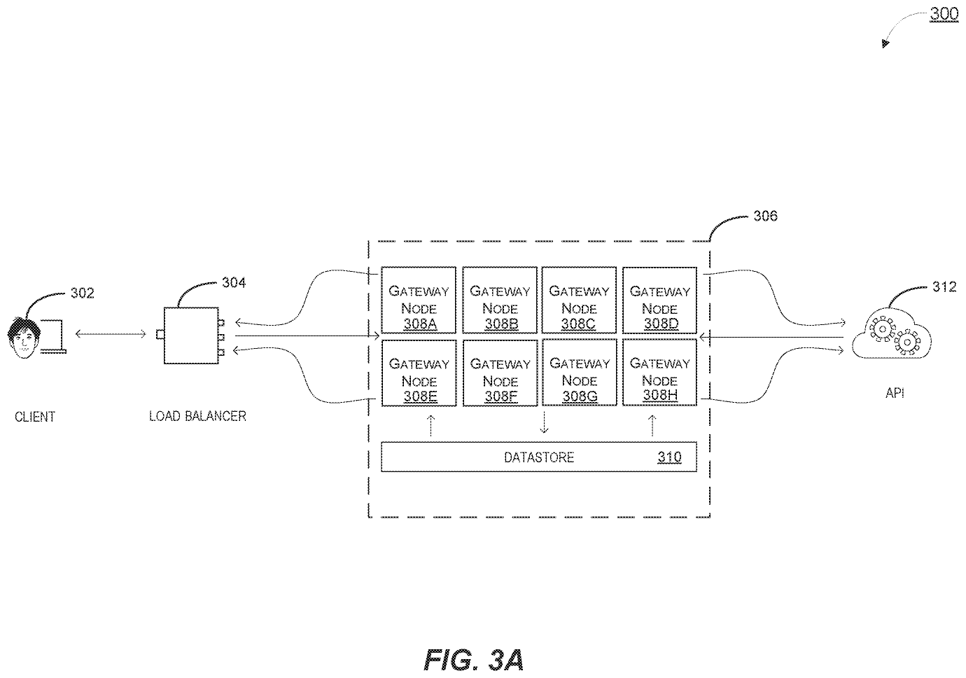

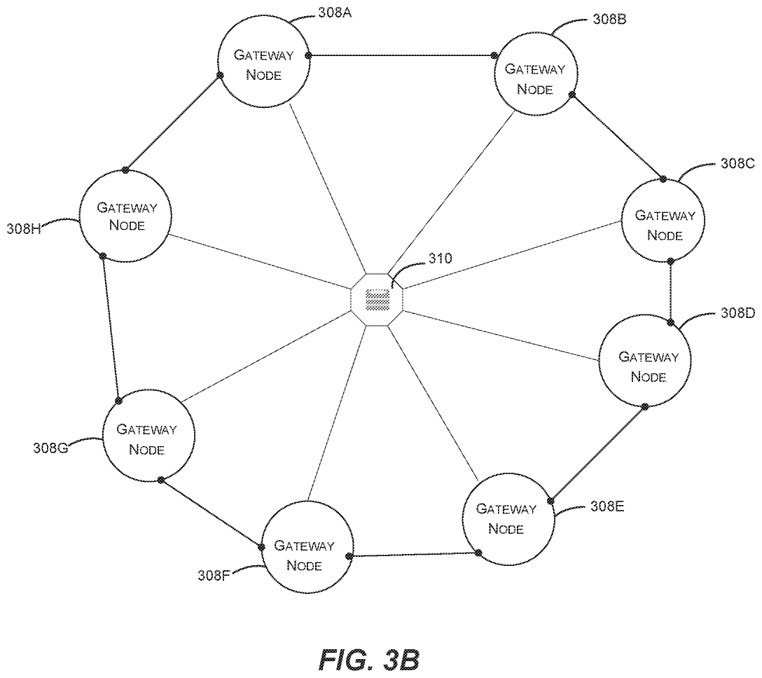

FIG. 3A illustrates a block diagram of an example environment with a cluster of gateway nodes in operation. In some embodiments, a gateway node is built on top of NGINX. NGINX is a high-performance, highly-scalable, highly-available web server, reverse proxy server, and web accelerator (combining the features of an HTTP load balancer, content cache, and other features). In an example deployment, a client 302 communicates with one or more APIs 312 via load balancer 304, and a cluster of gateway nodes 306. The cluster of gateway nodes 306 can be a distributed cluster. The cluster of gateway nodes 306 includes gateway nodes 308A-308H and data store 310. The functions represented by the gateway nodes 308A-308H and/or the data store 310 can be implemented individually or in any combination thereof, partially or wholly, in hardware, software, or a combination of hardware and software.

Load balancer 304 provides functionalities for load balancing requests to multiple backend services. In some embodiments, load balancer 304 can be an external load balancer. In some embodiments, the load balancer 304 can be a DNS-based load balancer. In some embodiments, the load balancer 304 can be a Kubernetes® load balancer integrated within the cluster of gateway nodes 306.

Data store 310 stores all the data, routing information, plugin configurations, etc. Examples of a data store can be Apache Cassandra or PostgreSQL. In accordance with disclosed embodiments, multiple gateway nodes in the cluster share the same data store, e.g., as shown in FIG. 3A. Because multiple gateway nodes in the cluster share the same data store, there is no requirement to associate a specific gateway node with the data store—data from each gateway node 308A—308H is stored in data store 310 and retrieved by the other nodes (e.g., even in complex multiple data center setups). In some embodiments, the data store shares configurations and software codes associated with a plugin that is installed at a gateway node. In some embodiments, the plugin configuration and code can be loaded at runtime.

FIG. 3B illustrates a schematic of a data store shared by multiple gateway nodes, according to an embodiment of the disclosed technology. For example, FIG. 3B shows data store 310 shared by gateway nodes 308A—308H arranged as part of a cluster.

One advantage of the disclosed architecture is that the cluster of gateway nodes allow the system to be scaled horizontally by adding more gateway nodes to encompass a bigger load of incoming API-related requests. Each of the gateway nodes share the same data since they point to the same data store. The cluster of gateway nodes can be created in one datacenter, or in multiple datacenters distributed across different geographical locations, in both cloud or on-premise environments. In some embodiments, gateway nodes (e.g., arranged according to a flat network topology) between the datacenters communicate over a Virtual Private Network (VPN) connection. The system can automatically handle a new gateway node joining a cluster or leaving a cluster. Once a gateway node communicates with another gateway node, it will automatically discover all the other gateway nodes due to an underlying gossip protocol.

In some embodiments, each gateway includes an administration API (e.g., internal RESTful API) for administration purposes. Requests to the administration API can be sent to any node in the cluster. The administration API can be a generic HTTP API. Upon set up, each gateway node is associated with a consumer port and an admin port that manages the API-related requests coming into the consumer port. For example, port number 8001 is the default port on which the administration API listens and 8444 is the default port for HTTPS (e.g., admin listen_ssl) traffic to the administration API.

In some instances, the administration API can be used to provision plugins. After a plugin is installed at a gateway node, it is available to be used, e.g., by the administration API or a declarative configuration.

In some embodiments, the administration API identifies a status of a cluster based on a health state of each gateway node. For example, a gateway node can be in one of the following states:
active: the node is active and part of the cluster.
failed: the node is not reachable by the cluster.
leaving: a node is in the process of leaving the cluster.
left: the node has left the cluster.

In some embodiments, the administration API is an HTTP API available on each gateway node that allows the user to create, restore, update, and delete (CRUD) operations on items (e.g., plugins) stored in the data store. For example, the Adm in API can provision APIs on a gateway node, provision plugin configuration, create consumers, and provision their credentials. In some embodiments, the administration API can also read, update, or delete the data. Generally, the administration API can configure a gateway node and the data associated with the gateway node in the data store.

In some applications, it is possible that the data store only stores the configuration of a plugin and not the software code of the plugin. That is, for installing a plugin at a gateway node, the software code of the plugin is stored on that gateway node. This can result in efficiencies because the user needs to update his or her deployment scripts to include the new instructions that would install the plugin at every gateway node. The disclosed technology addresses this issue by storing both the plugin and the configuration of the plugin. By leveraging the administration API, each gateway node can not only configure the plugins, but also install them. Thus, one advantage of the disclosed system is that a user does not have to install plugins at every gateway node. But rather, the administration API associated with one of the gateway nodes automates the task of installing the plugins at gateway nodes by installing the plugin in the shared data store, such that every gateway node can retrieve the plugin code and execute the code for installing the plugins. Because the plugin code is also saved in the shared data store, the code is effectively shared across the gateway nodes by leveraging the data store, and does not have to be individually installed on every gateway node.

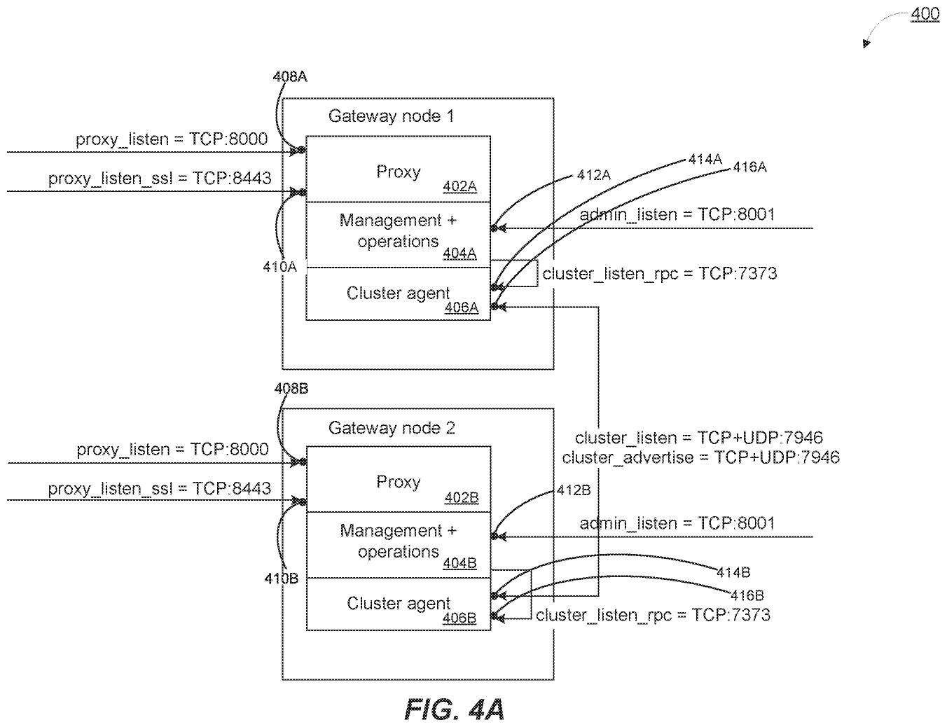

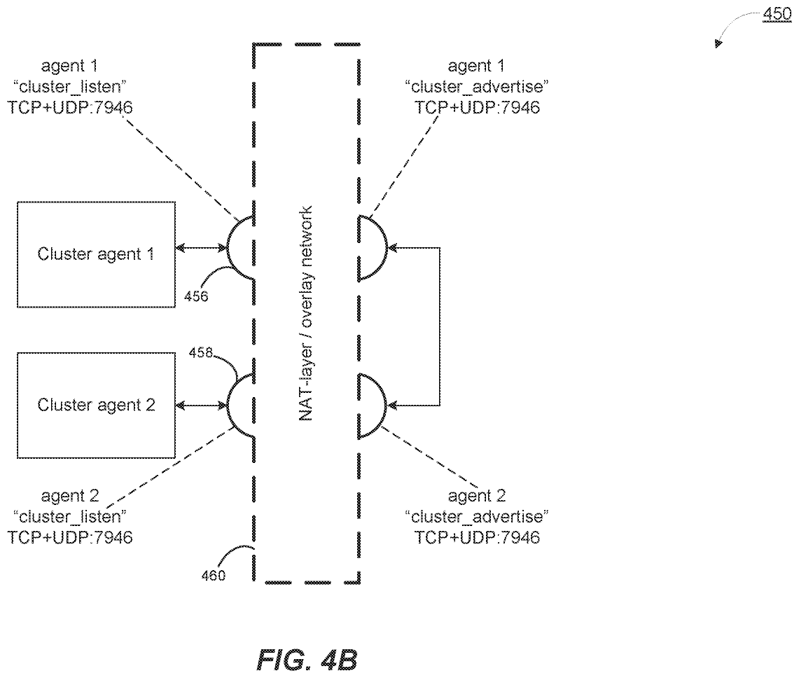

FIG. 4A and FIG. 4B illustrate example block diagrams 400 and 450 showing ports and connections of a gateway node, according to an embodiment of the disclosed technology. Specifically, FIG. 4A shows a gateway node 1 and gateway node 2. Gateway node 1 includes a proxy module 402A, a management and operations module 404A, and a cluster agent module 406A. Gateway node 2 includes a proxy module 402B, a management and operations module 404B, and a cluster agent module 406B. Gateway node 1 receive incoming traffic at ports denoted as 408A and 410A. Ports 408A and 410A are coupled to proxy module 402B. Gateway node 1 listens for HTTP traffic at port 408A. The default port number for port 408A is 8000. API-related requests are typically received at port 408A. Port 410A is used for proxying HTTPS traffic. The default port number for port 410A is 8443. Gateway node 1 exposes its administration API (alternatively, referred to as management API) at port 412A that is coupled to management and operations module 404A. The default port number for port 412A is 8001. The administration API allows configuration and management of a gateway node, and is typically kept private and secured. Gateway node 1 allows communication within itself (i.e., intra-node communication) via port 414A that is coupled to clustering agent module 406A. The default port number for port 414A is 7373. Because the traffic (e.g., TCP traffic) here is local to a gateway node, this traffic does not need to be exposed. Cluster agent module 406B of gateway node 1 enables communication between gateway node 1 and other gateway nodes in the cluster. For example, ports 416A and 416B coupled with cluster agent module 406A at gateway node 1 and cluster agent module 406B at gateway node 2 allow intra-cluster or inter-node communication. Intra-cluster communication can involve UDP and TCP traffic. Both ports 416A and 416B have the default port number set to 7946. In some embodiments, a gateway node automatically (e.g., without human intervention) detects its ports and addresses. In some embodiments, the ports and addresses are advertised (e.g., by setting the cluster advertise property/setting to a port number) to other gateway nodes. It will be understood that the connections and ports (denoted with the numeral “B”) of gateway node 2 are similar to those in gateway node 1, and hence is not discussed herein.

FIG. 4B shows cluster agent 1 coupled to port 456 and cluster agent 2 coupled to port 458. Cluster agent 1 and cluster agent 2 are associated with gateway node 1 and gateway node 2 respectively. Ports 456 and 458 are communicatively connected to one another via a NAT-layer 460. In accordance with disclosed embodiments, gateway nodes are communicatively connected to one another via a NAT-layer. In some embodiments, there is no separate cluster agent but the functionalities of the cluster agent are integrated into the gateway nodes. In some embodiments, gateway nodes communicate with each other using the explicit IP address of the nodes.

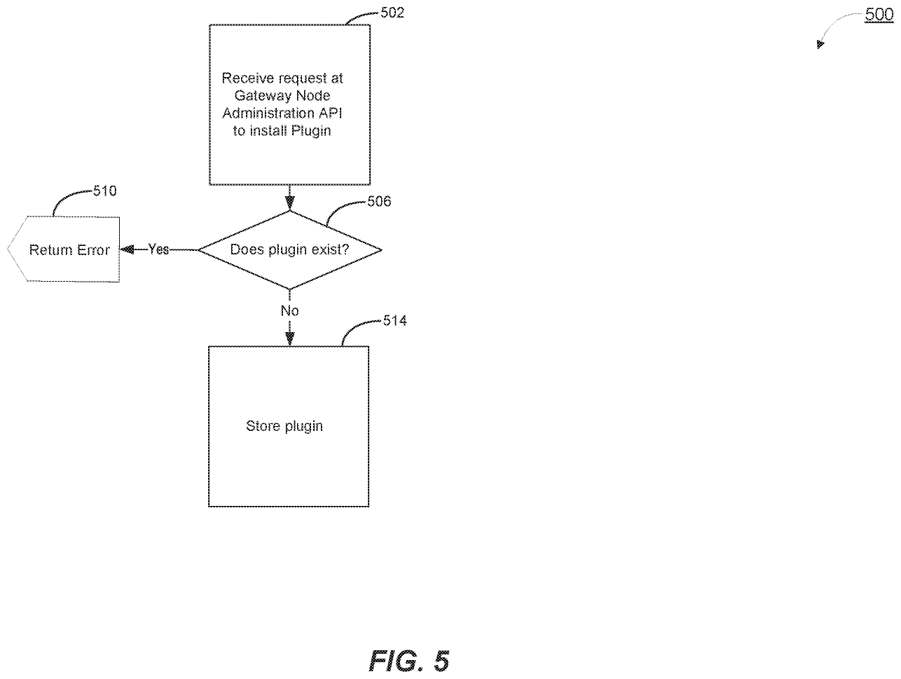

FIG. 5 illustrates a flow diagram showing steps of a process 500 involved in installation of a plugin at a gateway node, according to an embodiment of the disclosed technology. At step 502, the administration API of a gateway node receives a request to install a plugin. An example of a request is provided below:

For example:
POST /plugins/install
name=OPTIONAL_VALUE
code=VALUE
archive=VALUE

The administration API of the gateway node determines (at step 506) if the plugin exists in the data store. If the gateway node determines that the plugin exists in the data store, then the process returns (step 510) an error. If the gateway node determines that the plugin does not exist in the data store, then the process stores the plugin. (In some embodiments, the plugin can be stored in an external data store coupled to the gateway node, a local cache of the gateway node, or a third-party storage. For example, if the plugin is stored at some other location besides the data store, then different policies can be implemented for accessing the plugin.) Because the plugin is now stored in the database, it is ready to be used by any gateway node in the cluster.

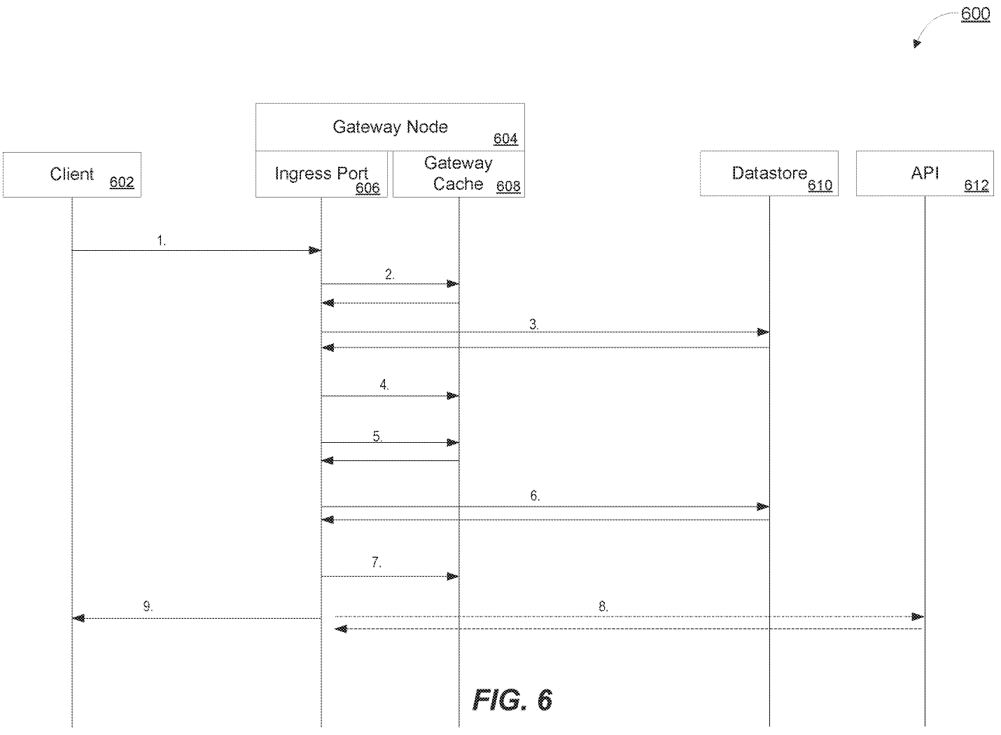

When a new API request goes through a gateway node (in the form of network packets), the gateway node determines (among other things) which plugins are to be loaded. Therefore, a gateway node sends a request to the data store to retrieve the plugin(s) that has/have been configured on the API and that need(s) to be executed. The gateway node communicates with the data store using the appropriate database driver (e.g., Cassandra or PostgresSQL) over a TCP communication. In some embodiments, the gateway node retrieves both the plugin code to execute and the plugin configuration to apply for the API, and then execute them at runtime on the gateway node (e.g., as explained in FIG. 6).

FIG. 6 illustrates a sequence diagram 600 showing components and associated steps involved in loading configurations and code at runtime, according to an embodiment of the disclosed technology. The components involved in the interaction are client 602, gateway node 604 (including an ingress port 606 and a gateway cache 608), data store 610, and an API 612. At step 1, a client makes a request to gateway node 604. At step 2, ingress port 606 of gateway node 604 checks with gateway cache 608 to determine if the plugin information and the information to process the request has already been cached previously in gateway cache 608. If the plugin information and the information to process the request is cached in gateway cache 608, then the gateway cache 608 provides such information to the ingress port 606. If, however, the gateway cache 608 informs the ingress port 606 that the plugin information and the information to process the request is not cached in gateway cache 608, then the ingress port 606 loads (at step 3) the plugin information and the information to process the request from data store 610. In some embodiments, ingress port 606 caches (for subsequent requests) the plugin information and the information to process the request (retrieved from data store 610) at gateway cache 608. At step 5, ingress port 606 of gateway node 604 executes the plugin and retrieves the plugin code from the cache, for each plugin configuration. However, if the plugin code is not cached at the gateway cache 608, the gateway node 604 retrieves (at step 6) the plugin code from data store 610 and caches (step 7) it at gateway cache 608. The gateway node 604 executes the plugins for the request and the response (e.g., by proxy the request to API 612 at step 7), and at step 8, the gateway node 604 returns a final response to the client.

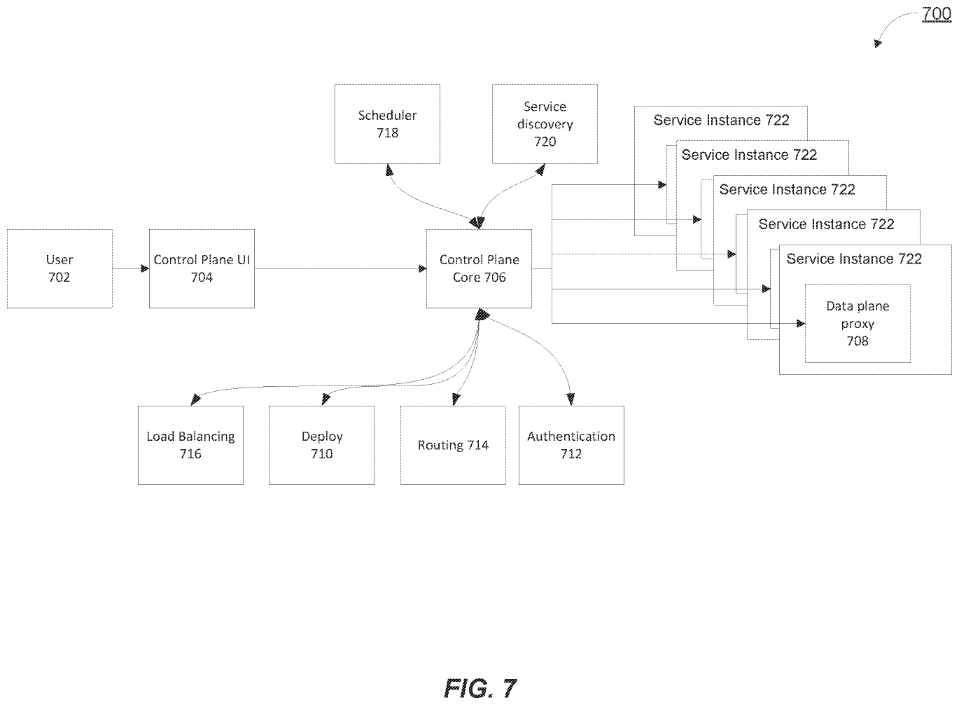

FIG. 7 is a block diagram of a control plane system 700 for a service mesh in a microservices architecture. A service mesh data plane is controlled by a control plane. In a microservices architecture, each microservice typically exposes a set of what are typically fine-grained endpoints, as opposed to a monolithic application where there is just one set of (typically replicated, load-balanced) endpoints. An endpoint can be considered to be a URL pattern used to communicate with an API.

Service mesh data plane: Touches every packet/request in the system. Responsible for service discovery, health checking, routing, load balancing, authentication/authorization, and observability.

Service mesh control plane: Provides policy and configuration for all of the running data planes in the mesh. Does not touch any packets/requests in the system but collects the packets in the system. The control plane turns all the data planes into a distributed system.

A service mesh such as Linkerd, NGINX, HAProxy, Envoy co-locate service instances with a data plane proxy network proxy. Network traffic (HTTP, REST, gRPC, Redis, etc.) from an individual service instance flows via its local data plane proxy to the appropriate destination. Thus, the service instance is not aware of the network at large and only knows about its local proxy. In effect, the distributed system network has been abstracted away from the service programmer. In a service mesh, the data plane proxy performs a number of tasks. Example tasks include service discovery, health checking, routing, load balancing, authentication and authorization, and observability.

Service discovery identifies each of the upstream/backend microservice instances within used by the relevant application. Health checking refers to detection of whether upstream service instances returned by service discovery are ready to accept network traffic. The detection may include both active (e.g., out-of-band pings to an endpoint) and passive (e.g., using 3 consecutive 5xx as an indication of an unhealthy state) health checking. The service mesh is further configured to route requests from local service instances to desired upstream service clusters.

Load balancing: Once an upstream service cluster has been selected during routing, a service mesh is configured load balance. Load balancing includes determining which upstream service instance should the request be sent; with what timeout; with what circuit breaking settings; and if the request fails should it be retried?

The service mesh further authenticates and authorizes incoming requests cryptographically using mTLS or some other mechanism. Data plane proxies enable observability features including detailed statistics, logging, and distributed tracing data should be generated so that operators can understand distributed traffic flow and debug problems as they occur.

In effect, the data plane proxy is the data plane. Said another way, the data plane is responsible for conditionally translating, forwarding, and observing every network packet that flows to and from a service instance.

The network abstraction that the data plane proxy provides does not inherently include instructions or built-in methods to control the associated service instances in any of the ways described above. The control features are the enabled by a control plane. The control plane takes a set of isolated stateless data plane proxies and turns them into a distributed system.

A service mesh and control plane system 700 includes a user 702 whom interfaces with a control plane UI 704. The UI 704 might be a web portal, a CLI, or some other interface. Through the UI 704, the user 702 has access to the control plane core 706. The control plane core 706 serves as a central point that other control plane services operate through in connection with the data plane proxies 708. Ultimately, the goal of a control plane is to set policy that will eventually be enacted by the data plane. More advanced control planes will abstract more of the system from the operator and require less handholding.

The control plane services may include global system configuration settings such as deploy control 710 (blue/green and/or traffic shifting), authentication and authorization settings 712, route table specification 714 (e.g., when service A requests a command, what happens), load balancer settings 716 (e.g., timeouts, retries, circuit breakers, etc.), a workload scheduler 718, and a service discovery system 720. The scheduler 718 is responsible for bootstrapping a service along with its data plane proxy 718. Services 722 are run on an infrastructure via some type of scheduling system (e.g., Kubernetes or Nomad). Typical control planes operate in control of control plane services 710-720 that in turn control the data plane proxies 708. Thus, in typical examples, the control plane services 710-720 are intermediaries to the services 722 and associated data plane proxies 708.

As depicted in FIG. 7, the control plane core 706 is the intermediary between the control plane services 710-720 and the data plane proxies 708. Acting as the intermediary, the control plane core 706 removes dependencies that exist in other control plane systems and enables the control plane core 706 to be platform agnostic. The control plane services 710-720 act as managed stores. With managed storages in a cloud deployment, scaling and maintaining the control plane core 706 involves fewer updates. The control plane core 706 can be split to multiple modules during implementation.

The control plane core 706 passively monitors each service instance 722 via the data plane proxies 708 via live traffic. However, the control plane core 706 may take active checks to determine the status or health of the overall application.

The control plane core 706 supports multiple control plane services 710-720 at the same time by defining which one is more important through priorities. Employing a control plane core 706 as disclosed aids control plane service 710-720 migration. Where a user wishes to change the control plane service provider (ex: changing service discovery between Zookeper based discovery to switch to Consul based discovery), a control plane core 706 that receives the output of the control plane services 710-720 from various providers can configure each regardless of provider. Conversely, a control plane that merely directs control plane services 710-720 includes no such configuration store.

Another feature provided by the control plane core 706 is Static service addition. For example, a user may run Consul, but you want to add another service/instance (ex: for debugging). The user may not want to add the additional service on the Consul cluster. Using a control plane core 706, the user may plug the file-based source with custom definition multi-datacenter support. The user may expose the state hold in control plane core 706 as HTTP endpoint, plug the control plane core 706 from other datacenters as a source with lower priority. This will provide fallback for instances in the other datacenters when instances from local datacenter are unavailable.

Service Group Discovery and Observation

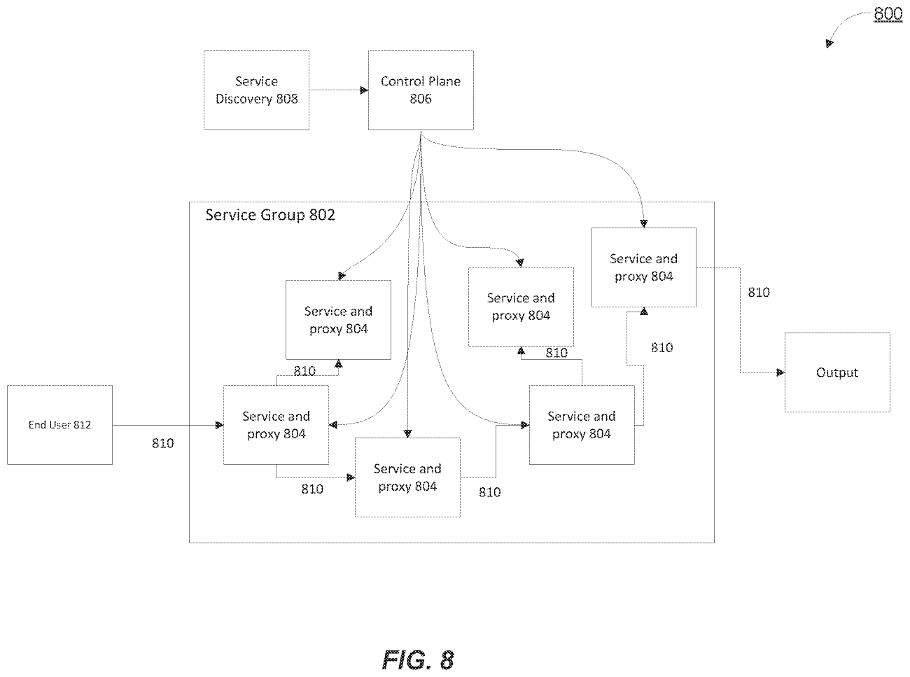

FIG. 8 is a block diagram illustrating service groups 802 and features associated with identification thereof. A service group 802 is a group of services 804 that together perform an identifiable application purpose or business flow. For example, a set of microservices are responsible for an airline's ticketing portion of their website. Other examples may include “customer experience,” “sign up,” “login,” “payment processing”, etc. Using a control plane 806 with an associated service discovery 808 feature, packets are be monitored as they filter through the overall application (ex: whole website).

Given a starting point of a given service group 802, the control plane 806 may run a trace on packets having a known ID and follow where those packets (with the known ID) go in the microservice architecture as tracked by data plane proxies. In that way, the system can then automatically populate a service group 802 using the trace. The trace is enabled via the shared execution path of the data plane proxies. Along each step 810 between services 804, the control plane 804 measures latency and discover services. The trace may operate on live traffic corresponding to end users 812, or alternatively using test traffic.

As output, the control plane generates a dependency graph of the given service group 802 business flow and reports via a graphic user interface (GUI). Using the dependency graph, a backend operator is provided insight into bottlenecks in the service group 802. For example, in a given service group 802, a set of services 804 may run on multiple servers that are operated by different companies (e.g., AWS, Azure, Google Cloud, etc.). The latency between these servers may slow down the service group 802 as a whole. Greater observability into the service group 802 via a dependency graph enables backend operators to improve the capabilities and throughput of the service group 802.

Hybrid Mode

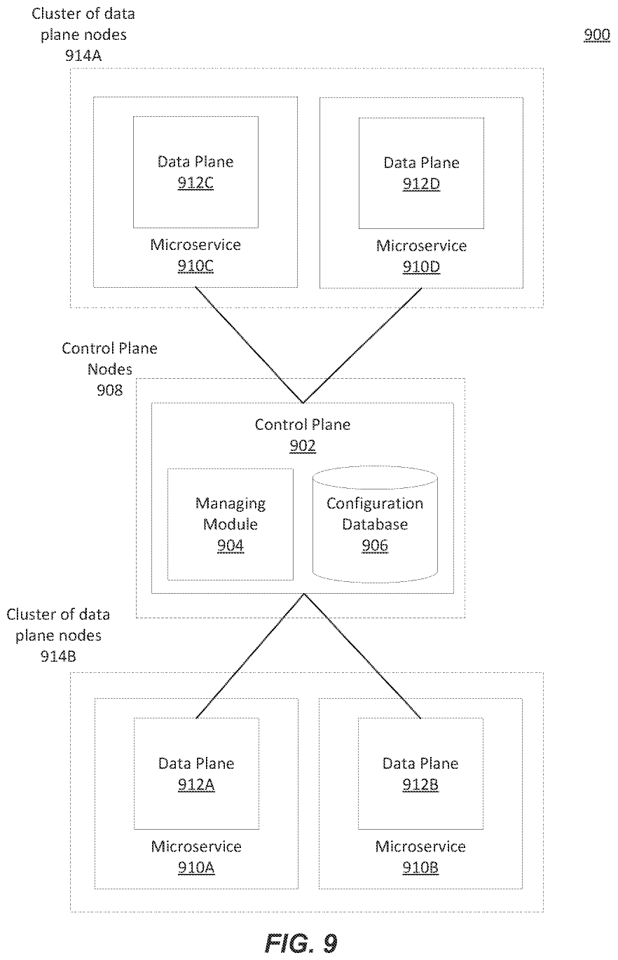

FIG. 9 is a block diagram illustrating an example environment 900 of a control plane 902 and clusters 914 of nodes. The control plane 902 is connected to data planes 912 associated with the clusters of nodes, and each data plane 912 serves traffic for a microservice 910 of a plurality of microservices 910. Though only four microservices 910 are shown in FIG. 9, any number of microservices 910 may be connected to the control plane 902. In some embodiments, additional or alternative components to those shown in the example environment 900 are connected (either directly or via a network) to the control plane 902. For example, in some embodiments, the example environment includes more nodes than shown in FIG. 9. In another example, each cluster includes more microservices 910 than shown in FIG. 9.

In some embodiments, the control plane 902 connects to the components via a network. The network is any collection of distinct networks operating wholly or partially in conjunction to provide connectivity to/from between the components. In one embodiment, network communications can be achieved by, an open network, such as the Internet, or a private network, such as an intranet and/or the extranet. Examples of the network include a telephonic network, an open network, such as the Internet, or a private network, such as an intranet and/or the extranet. For example, the Internet provides file transfer, remote login, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

The control plane 902 links nodes of the plurality of microservices 910 for a microservice architecture application. The control plane 902 communicates with the microservices 910 (via the data planes 912) to facilitate running the microservice architecture application. For example, the control plane 902 is enabled to send instructions for configuring settings of the microservices 904 and send data for the microservice architecture application to the microservices 904 for processing. The control plane 902 may also receive outputs from the microservices 904 for the processing, which allows the control plane 902 to maintain an overview of how the microservices 904 are operating for the microservice architecture application.

Each microservice 904 is an API (such as API 208 or API 312 or service instance 722) that performs actions for the microservice architecture application and is configurable based on communications received from the control plane 902. Each microservice 910 generates data in the data plane 912 and communicates the data to the control plane 902 via a number of potential implementations. For example, in some embodiments, each microservice 910 is attached to a data plane 912 configured to communicate information generated at the microservice 910 to the control plane 902. The data plane 902 runs simultaneously with the microservice 910. In another example, a data plane 912 serves as a gateway for all of the microservices 910 employed for the microservice architecture application. In another example, a data plane 912 serves traffic for a subset of the plurality of microservices 910, such as microservices 910 associated with a particular node, function, service group, or the like. The control plane 902 sends configuration instructions and input data to a data plane 912 associated with each microservice 904 and receives output data from each microservice's associated data plane 912. The control plane 902 does not directly observe a microservice's 910 settings, so the control plane 902 instead requests current settings or configurations from a microservice's 910A data plane 912A to determine what settings the microservice 904 is operating under.

The microservice architecture application is a computer program that performs one or more functions. The microservice architecture application is facilitated by the control plane 902 such that processes for running the microservice architecture application are distributed among the plurality of microservices 910 connected to the control plane 902. In some embodiments, the control plane 902 facilitates the processing of multiple microservice architecture applications by distributing the processes for the microservice architecture applications across the plurality of microservices 910. For instance, the control plane 902 may break down the processing required for each microservice architecture application into a set of processes and determine, for each process, a set of requirements, including how much computing power, memory, storage, and the like is needed for performing the process.

The control plane 902 requests data indicating the ability (e.g., graphics processing units available, storage available, etc.) of one or more microservices 910 to run the processes and selects a microservice 910 for each process based on this data. In addition, the control plane 902 monitors the ability of the microservices 910 over time to redistribute processes among the microservices 910 based on this data.

The control plane 902 monitors microservices 910 as the microservices 910 perform operations for the microservice architecture application. When instantiating the microservice architecture application, the control plane selects a plurality of microservices 910 to each perform a process for the microservice architecture application. The control plane 902 sends, to each microservice 910, instructions for configuring the settings of the microservice 910 to perform the process and sends input data for the process. The control plane 902 stores a record of the instructions and the settings in a database. The database is located within the control plane 902. In alternate embodiments, the database is connected to the control plane 902 via the network. In some embodiments, the control plane 902 stores the record in relation to a time the instructions were sent. Further, the control plane 902 may store the data in relation to an identifier of the microservice 910 such that the control plane 902 can query the database with the identifier to retrieve instructions, settings, event hooks, plugins, and the like associated with the microservice 910.

In some embodiments, the control plane 902 communicates (e.g., sends input data for processing, sends instructions for setting configurations, and/or receives output data) with the microservices 904 via one or more data planes 912. A data plane 912 functions as an intermediary between the control plane 902 and one or more microservices 910 to provide security and privacy and control the requests sent between the control plane 902 and the microservices 910. The data planes 912 function like the gateway nodes 206, 308, 604 described in relation to FIGS. 2-6 or the proxies 708, 804 described in relation to FIGS. 7-8. In some embodiments, a data plane 912A serves as a gateway for a single microservice 910A of the plurality of microservices 910 employed for the microservice architecture application. For example, the data plane 912A may function as a gateway between the microservice 910A and an external application, a client, and/or the control plane 902. When a new data plane node (with a microservice 910 and data plane 912) is created for the microservice architecture application (e.g., by a consumer via a GUI), the data plane node establishes connection with the control plane 902, which tracks incoming data from the data plane 912.

In other embodiments, a data plane 912 serves as a gateway for a subset or all of the plurality of microservices 910 employed for the microservice architecture application. Further, in certain embodiments, the data planes 912 each store subsets of the database at the request of the control plane 902. For instance, the control plane 902 requests that a data plane 9126 store a subset of the database related to associated microservice 910B. Though data planes 912 act as gateways for communication between the control plane 902 and microservices 910 in a plurality of embodiments, for simplicity, the communications are often described herein as occurring directly between the control plane 902 and the microservices 910.

The control plane 902 may communicate information for the microservice architecture application with a client. The control plane 902 transmits GUIs with this information for display to the client for providing the administration API. A GUI includes interactive elements that the client may interact with to display the information for the microservice architecture application. The client selects interactive elements based on the information desired to be displayed and to send input data to the control plane 902 for the microservice architecture application. For example, the client inputs configurations for one or more selected microservices 910 via a GUI. Other actions made by the client via the GUI include selecting an external application to connect to the microservices 910, inputting selection criteria (e.g., geography, region, time zone, processing power, etc.) for which microservices 910 or nodes to employ for the microservice architecture application, and the like. The control plane 902 communicates information about the client's interactions with the GUI to the other components and updates the GUI based on the interactions and output data from the other components.

The microservices 910 are associated with nodes in the example environment 900. Each node is a server (e.g., a processor) capable of sending and processing data within the example environment 900. In some embodiments, a node is a simple operating system process. In some embodiments, a node is a physical device that is able to send and receive information in the example environment 900. Each node is capable of hosting one or more microservices 910 that perform functions for the microservice architecture application. The nodes may be distributed across different data centers, geographies, and/or time zones, and each node stores an indication of this location information.

The components of the example environment 900 run on nodes that the control plane 902 links together into clusters. In particular, the control plane 902 determines a subset of the microservices 910 employed for the microservice architecture application. The control plane 902 accesses information about each microservice 910 servicing the microservice architecture application and/or each microservice 910 not already linked into a cluster. The control plane 902 may retrieve this information as stored in an internal database in association with an identifier of each microservice or may request the information from the microservices 910 via their data planes 912. The information for a microservice 910A includes type of functions (e.g., processes) performed by the microservice 910, associated microservices 910 (e.g., a service group) that the microservice 910A performs processes in conjunction with, locations (e.g., data center, geography, time zone, etc.) of a node associated with the microservice 910A, and the like.

The control plane 902 groups microservices 910 into subsets based on category. The categories include service group, type of function, and node location. For instance, in some embodiments, the control plane 902 groups microservices 910 into a subset based on the microservices 910 acting together in a service group to perform one or more related processes for the microservice architecture application. For example, the control plane 902 groups together microservices 910 that together perform processing for a computer vision model. In some embodiments, the control plane 902 groups microservices 910 into a subset based on the microservices 910 each performing the same type of function (e.g., each microservice that runs processes for a GUI for clients) or related types of functions (e.g., a first microservice that runs a machine learning model and a second microservice that trains the machine learning model, etc.). In some embodiments, the control plane 902 groups microservices 910 based on locations of nodes that run the microservices 910. For example, the control plane 902 groups microservices 910 with nodes in Austin together, microservices 910 with nodes in the Pacific time zone together, or microservices 910 with nodes at a particular data center together. The control plane 902 may additionally group microservices 910 based on any set of criteria, such as name of the microservices 910, clients or other entities associated with the microservices 910, models run by the microservices 910, configured entities (routes, services, plugins) installed at the microservices 910 or their data planes 912, and the like.

The control plane 902 links the nodes of the microservices 910 in a subset into clusters 914. The nodes in the clusters 914 are referred to as data plane nodes, whereas the nodes that are not clustered and are used to run the control plane 902 are referred to as control plane nodes 908. The nodes in a subset may be at different node locations, providing more flexibility than systems that need a local clustered database. During linking, the control plane 902 does not connect to microservices 910 with data planes 912 that do not have the same major version as the control plane 902. For example, when the control plane 902 has version v2.5.2, the control plane will connect to a first data plane 912A with version v2.5.9 but not to a second data plane 912B with version v1.0.0.

To link the nodes, the control plane 902 stores identifiers of the nodes in an internal database of clusters 914. The control plane 902 also stores identifiers of the microservices 910 and data planes 912 associated with the subset for the cluster 914 in association with the identifiers of the nodes. For example, the control plane 902 stores the identifiers in an index of clusters 914 that the control 902 plane can query to identify nodes, microservices 910, and data planes 912 in the same cluster 914. The control plane additionally stores configurations of the nodes in a cluster 914 in association with their identifiers. Configurations include configured entities, such as routes, services, and plugins, and versions of the configured entities. In some embodiments, the control plane 902 links nodes of the subset into a cluster 914 by putting the data planes 912 associated with the nodes in communication with one another such that the control plane 902 does not need to facilitate communication between the data planes 912. The control plane 902 creates a certificate and key pair for distribution to the data plane nodes for inter-cluster communication (e.g., using mutual authentication to secure the nodes). In some embodiments, the control plane 902 provides certificates signed by a central authority and validates certificates by determining that the certificates are from the same central authority. In some embodiments, the control plane 902 checks for revocation of a data plane's 912 certificate.

The control plane 902 updates configurations of nodes in the cluster 914. The control plane 902 includes one or more configured entities used for managing the components of the example environment 900 and the microservice architecture application. A configured entity may be a route, service, or plugin or may be a configured plugin that is either enabled globally or configured by routes, services, or consumers. When a configured entity is updated with a new configuration at the control plane 902, the control plane 902 queries the internal database for clusters 914 of nodes with data planes 912 installed and loaded with the same configured entity. For each data plane 912 of a cluster 914, the control plane 902 determines compatibility between the major and minor versions of the configured entity at the control plane 902 and at the data plane 912. If the major versions at the control plane 902 and the data plane 912 match and the minor version at the data plane 912 is not newer than the minor version at the control plane 902, the control plane 902 pushes the new configuration to the data plane 912. The control plane 902 does not check patch versions of the configured entity when assessing compatibility.

The control plane 902 can check compatibility of configured entities at microservices 910 in a similar fashion through communicating with data planes 912 about major and minor versions of the configured entities and subsequently push new configurations to the microservices 910 for the nodes. For simplicity, however, the processes herein are described in relation to the data planes 912. The control plane 902 checks compatibility at configuration read time and stores an indication of compatibility after a check in the internal database in association with the identifier of the data plane 912.

For example, the control plane 902 has a first plugin with version v1.1.1 installed and a second plugin with version v.2.1.0 installed. The versions are ordered by major version, minor version, and revision (e.g., major version.minor version.revision). The control plane 902 checks compatibility with a plurality of data planes 912. The control plane 902 pushes a new configuration for the first and second plugin to a first data plane 912A that has the first plugin with version v1.1.2 installed and does not have the second plugin installed because the first plugin has the same major and minor versions (but a different revision). For a second data plane 912B with the same first and/or second plugin installed and a third plugin installed, the control plane 902 also pushes the new configuration. A third data plane 912C with the first plugin with version v.1.2.0 does not receive the new configuration from the control plane 902 since the third data plane's 912C minor version is newer than that of the control plane 902. Further, the control plane 902 does not push the new version to a fourth data plane 912D that does not have the first or second plugin installed.

When a data plane 912 receives a new configuration from the control plane 902, the data plane 912 checks to see whether it can enable the requested features of the new configuration. For example, the data plane 912 ensures that data plane's 912 node has the processing power and memory needed for the new configuration. If the new configuration from the control plane 902 is newer than that for the same configured entity at the data plane 912 and does not include any new features, the data plane 912 reads and applies the new configuration. For example, the control plane 902 is updated with a new version that includes a new plugin offering. In this example, the control plane 902 sends new configurations to data planes 912 that meet the compatibility standard but must do so without the new plugin offering. To update the data planes 912 with the new plugin offering, the control plane 902 also updates the data planes 912 to the new version.

If a data plane 912 does not meet compatibility with the control plane 902, the control plane 902 determines that the data plane 912 is incompatible, and the control plane 902 stores an indication of incompatibility in the internal database. The control plane 902 checks the internal database for indications of incompatibility of a data plane 912 before sending out a new configuration. If a data plane 912 is incompatible, the control plane 902 does not send out new configurations to the data plane 912 to avoid breaking the data plane 912. The control plane 902 contains a warn level line in an error log when new configurations cannot be pushed to a data plane 912. Examples of warn level lines include “unable to send updated configuration to DP node with hostname: localhost.localdomain ip: 127.0.0.1 reason: version mismatch” and “unable to send updated configuration to DP node with hostname: localhost.localdomain ip: 127.0.0.1 reason: CP and DP does not have same set of plugins installed or their versions might differ.” Further, the control plane 902 determines the last compatible version employed at the incompatible data plane 912 by checking the internal database and instructs the data plane 912 to revert to the last compatible version.

If the control plane nodes 908 go down (e.g., are not powered or otherwise are not functioning as expected), data plane nodes of the clusters 914 continue running. In particular, each data plane 912 of the nodes caches a latest configuration received from the control plane 902 in a local database of the data plane's 912 node. When the control plane 902 is down, the data planes 912 continue to serve requests using the cached configurations while trying to reestablish communication with the control plane 902. Further, the data plane nodes can be restarted or otherwise stopped for time periods while the control plane 902 is down and still proxy traffic as needed for the microservice architecture application. When restarted, the data plane nodes will load a latest configuration into a local database (or cache) to start functioning, and when the control plane 902 is back online, the data plane nodes resume connection to the control plane 902. These features improve reliability of use of the microservices 910 and nodes for the microservice architecture application.

The data planes 912 continue to perform even when disconnected from the control plane 902, allowing the control plane 902 to perform updates or database restores without disrupting the processes at the data planes 912. During these down times, the data planes 912 continue to operate with latest configurations. Further, a new data plane node can be provisioned while the control plane 902 is down. For instance, a consumer, via a GUI, provisions a new data plane node by copying a configuration cache file (e.g., config.json.gz, in some embodiments) from another data plane node or by using a declarative configuration (e.g., a version declared by the consumer). The new data plane node tries to connect to the control plane 902 after provisioning. The consumer may also disconnect a configuration of a data plane node while the control plane 902 is down. For instance, the consumer removes the configuration cache file, sets a declarative parameter to indicate that the consumer is declaring a configuration, and sets the configuration in a YAML file.

The features described herein result in numerous benefits for consumers of the microservice architecture application. First, consumers can deploy data plane nodes of a cluster 914 in different data centers, geographies, and zones without the need for a local clustered database for the cluster 914. Second, use of the data plane nodes improve reliability of the system of the example environment 900. In particular, even if the control plane nodes 908 are down, the data plane nodes continue to function using locally cached configurations. Next, traffic to the internal database of configurations is lessened compared to conventional systems since only control plane nodes 908, rather than also data plane nodes, need to be directly connected to the internal database. Further, if a data plane node is compromised by an attacker, the other data plane nodes in the data plane node's cluster 914 are secure since they do not directly expose the administration API located at the control plane 902. Lastly, consumers can more easily manage clusters 914 of data plane nodes through using the control plane 902 to control and monitor status of the clusters 914.

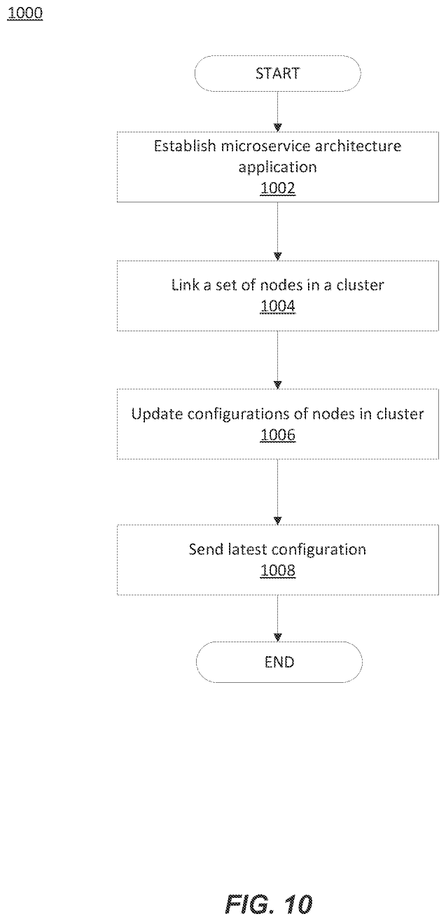

FIG. 10 is a flowchart 1000 illustrating a process for sending a latest configuration to data planes 912 associated with a cluster 914. Though the embodiment described in the flowchart 1000 involves components in the example environment 900 of FIG. 9, in some embodiments, additional or alterative components may be used to send configurations to data planes 912 of a cluster 914.

At step 1002, the control plane 902 establishes a microservice architecture application. The microservice architecture application includes a plurality of microservices 910, each configured to perform a piecemeal function of an overall application function. The plurality of microservices 910 are managed by the control plane 902. Each microservice 910 includes a data plane 912 that serves traffic to and from the control plane 902 for the microservice 910. The microservices 910 are run at one or more nodes that may be spread across a variety of node locations.

The control plane 902 determines a subset of nodes of the plurality of microservices 910. For instance, the control plane 902 groups nodes into a subset based on the node's microservices 910 being associated with one or more categories. The categories include microservices 910 associated with one or more of a service group of microservices 910 that together perform one or more related processes for the microservice architecture application or a type of function performed by microservices 910 associated with the category. The nodes of the microservices 910 may be distributed among different node locations (data centers, geographies, and/or time zones). In some embodiments, the control plane 902 may group the microservices 910 based on their nodes having similar node locations.

At step 1004, the control plane 902 links a set of nodes associated with a subset of the plurality of microservices 910 and a corresponding set of data planes 912 into a cluster 914. The control plane 902 uses a certificate key pair to establish inter-cluster communication between the nodes and data planes 912 and stores identifiers of the components in the cluster 914 in an internal database.

At step 1006, the control plane 902 updates configurations of nodes in the cluster 914 to a latest configuration. For instance, the control plane 902 updates at the nodes to the latest configuration. At step 1008, the control plane 902 sends the latest configuration to each of the corresponding data planes 912 associated with the cluster 914 of the node. Each data plane 912 caches the latest configuration on a local storage disk of its associated node in the cluster 914.

In some embodiments, alterative or additional steps or modules are used in the process shown in FIG. 10. For example, in some embodiments, the control plane 902 determines one or more of the microservices 910 of the subset that have a plugin installed and pushes a new configuration for the plugin to the data planes 912 of the one or more microservices 910 of the subset. The data planes 912 the subset have a same major version, and the minor versions of plugins at the data planes 912 of the subset are not newer than a version installed at the control plane 902. In some embodiments, the control plane 902 pushes a new version of an application (selected by a consumer) serviced by the subset of microservices 910 to the data planes 912 of the subset. The new version includes a new plugin.

In some embodiments, in response to an action at the control plane 902 (e.g., via the administration API and/or the GUI), the control plane 902 triggers an update identifying the action to the data planes 912 the subset of microservices 910. For example, a consumer may select an interactive element indicating she wants a function for an application to run at the microservices 910. The data planes 912 receive an update identifying the function and cause the microservices 910 to perform the function. In another example, the control plane 902 receives an indication from a consumer to restart the nodes in a cluster 914. The data planes 912 of the cluster 914 receive the indication from the control plane 902 and cause the nodes to restart.

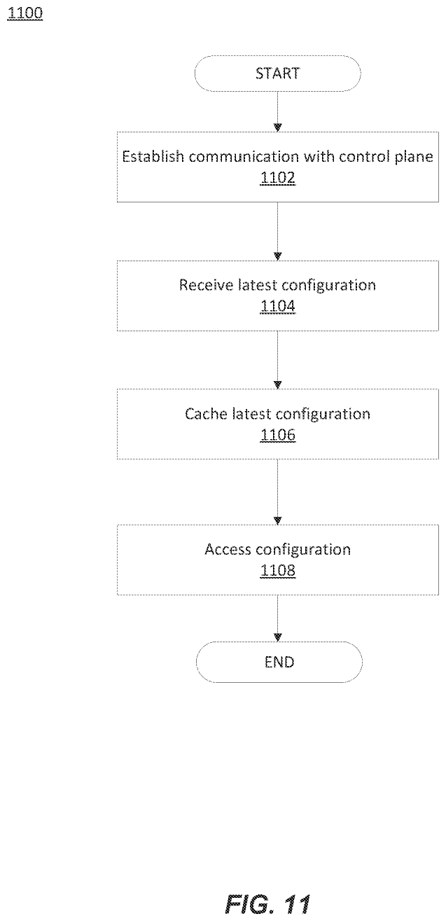

FIG. 11 is a flowchart 1100 illustrating a process for accessing a configuration to serve a microservice 910. Though the embodiment described in the flowchart 1100 involves components in the example environment 900 of FIG. 9, in some embodiments, additional or alterative components may be used.

At step 1100, a first data plane 912A establishes communication with the control plane 902, which manages a microservice architecture application. In some embodiments, the microservice architecture application includes a plurality of clusters 914 of microservices 910, where each cluster 914 is associated with one or more categories. Each category is associated with a service group of microservices 910 that together perform one or more related processes for the microservice architecture application and/or is associated with a type of function performed by microservices 910 of the category. The first data plane 912A is associated with a first microservice 910A of a plurality of microservices 910 in a distributed gateway architecture, and each microservice 910 of the plurality of microservices 910 is configured to perform a piecemeal function of an overall application function. Further, the first data plane 912A is associated with a cluster 914A of data planes 912.

At step 1104, the first data plane 912A receives a latest configuration from the control plane 902, which the control plane 902 sent to each data plane 912 associated with the cluster 914A. At step 1106, the first data plane 912A caches the latest configuration on a local storage disk of an associated node that runs the data plane 912A and its microservice 910A. At step 1108, the first data plane 912A accesses the configuration at the local storage disk to serve the first microservice 910A. For example, the first data plane 912A may use the configuration to process data at the first microservice 910A via one or more configured entities.

In some embodiments, alterative or additional steps or modules are used in the process shown in FIG. 11. For example, in some embodiments, responsive to the control plane 902 being down, the first data plane 912A sends a request to reestablish communication with the control plane 902. In some embodiments, responsive to the control plane 902 being down, the first data plane 912A continues to serve requests for the first microservice 910A based on the cached configuration. In some embodiments, responsive to receiving a configuration update form the control plane 902, the first data plane 912A determines whether it can enable requested features of the configuration update. Responsive to determining that the configuration update does not include new features from a newer version at the control plane 902, the first data plane 912A caches the configuration update at the local storage disk of the node.

In some embodiments, the first data plane 912A receives an update from the control plane 902 that identifies an action that occurred at the control plane 902. In these embodiments, the update was sent in response to the action at the control plane 902, and the first data plane 912A takes action on the update. For instance, the first data plane 912A may cause the first microservice 910A to perform the same action as or a related action to that that occurred at the control plane 902. For example, the update may indicate that the control plane 902 performed a health check, and the first data plane 912A performs its own health check in response to the update.

### Exemplary Computer System

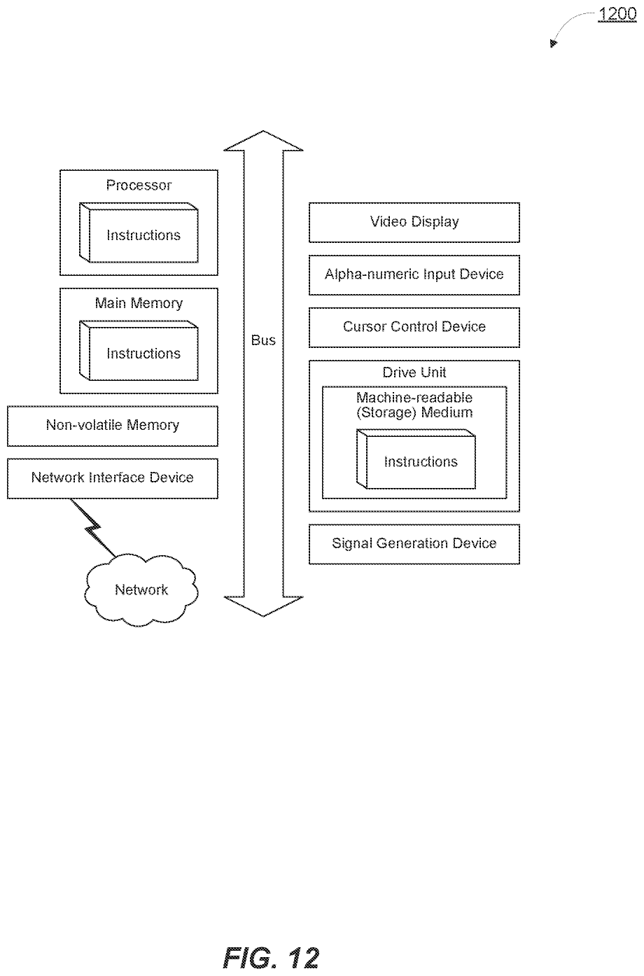

FIG. 12 shows a diagrammatic representation of a machine in the example form of a computer system 1200, within which a set of instructions for causing the machine to perform any one or more of the methodologies discussed herein may be executed.

In alternative embodiments, the machine operates as a standalone device or may be connected (networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone or smart phone, a tablet computer, a personal computer, a web appliance, a point-of-sale device, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Discs, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

All patents, applications and references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for.”) Accordingly, the applicant reserves the right to add additional claims after filing the application to pursue such additional claim forms for other aspects of the disclosure.

1. A method comprising:
establishing a microservice architecture application including a plurality of microservices, each microservice configured to perform a piecemeal function of an overall application function, the plurality of microservices managed by an application control plane;
linking in a cluster, by the application control plane, a set of nodes associated with a subset of the plurality of microservices and a corresponding set of data planes;
updating, by the application control plane, configurations of nodes in the cluster executing at the application control plane to a latest configuration; and
sending, by the application control plane, the latest configuration to each of the corresponding data planes associated with the cluster, wherein each data plane caches the latest configuration on a local storage disk of an associated node in the cluster.

2. The method of claim 1, wherein the microservice architecture application includes a plurality of clusters of microservices, each cluster associated with one or more categories, each category associated with one or more of a service group of microservices that together perform one or more related processes for the microservice architecture application or a type of function performed by microservices associated with the category.

3. The method of claim 1, wherein the nodes in the set of nodes are distributed among different data centers, geographies, and/or time zones.

4. The method of claim 1, further comprising:
determining one or more of the microservices of the subset that have a plugin installed; and
pushing, by the application control plane, a new configuration for the plugin to the data planes of the one or more microservices of the subset.

5. The method of claim 4, wherein the data planes of the one or more microservices of the subset have a same major version.

6. The method of claim 4, wherein minor versions of plugins at the data planes of the one or more microservices of the subset are not newer than a version installed at the application control plane.

7. The method of claim 1, further comprising:
pushing, to the data planes of the subset of microservices, a new version of an application serviced by the subset of microservices, wherein the new version includes a new plugin.

8. The method of claim 1, further comprising:
in response to an action at the application control plane, triggering an update to the data planes of the subset of microservices, wherein the update identifies the action.

9. A method comprising:
establishing, at a first data plane of a first microservice of a plurality of microservices in a distributed gateway architecture, communication with an application control plane that manages a microservice architecture application, each microservice of the plurality of microservices configured to perform a piecemeal function of an overall application function, wherein the first data plane is associated with a cluster of data planes;
receiving, from the application control plane, a latest configuration sent to each data plane associated with the cluster; and
caching, by the first data plane, the latest configuration on a local storage disk; and
accessing the configuration at the local storage disk to serve the first microservice.

10. The method of claim 9, further comprising:
responsive to the application control plane being down, sending, by the first data plane, a request to reestablish communication with the application control plane.

11. The method of claim 9, further comprising:
responsive to the application control plane being down, continuing, by the first data plane, to serve requests for the first microservice based on the cached configuration.

12. The method of claim 9, further comprising:
responsive to receiving, from the application control plane, a configuration update, determining whether the first data plane can enable requested features of the configuration update; and
responsive to determining that the configuration update does not include new features from a newer version at the application control plane, caching the configuration update at the local storage disk.

13. The method of claim 9, wherein the microservice architecture application includes a plurality of clusters of microservices, each cluster associated with one or more categories, each category associated with one or more of a service group of microservices that together perform one or more related processes for the microservice architecture application or a type of function performed by microservices associated with the category.

14. The method of claim 9, further comprising:
receiving, from the application control plane, an update identifying an action at the application control plane, the update sent in response to the action at the application control plane.

15. A system comprising:
a microservice executing on a node; and
a memory having instructions stored thereon, that when executed cause the node to perform actions comprising:
establishing, at a first data plane of a first microservice of a plurality of microservices in a distributed gateway architecture, communication with an application control plane that manages a microservice architecture application, each microservice of the plurality of microservices configured to perform a piecemeal function of an overall application function, wherein the data plane is associated with a cluster of data planes;
receiving, from the application control plane, a latest configuration sent to each data plane of associated with the cluster; and
caching, by the first data plane, the latest configuration on a local storage disk; and
accessing the configuration at the local storage disk to serve the first microservice.

16. The system of claim 15, wherein the microservice architecture application includes a plurality of clusters, each cluster associated with one or more categories.

17. The system of claim 16, wherein each category is associated with a service group of microservices that together perform a purpose for the microservice architecture application.

18. The system of claim 15, the actions further comprising:
responsive to the application control plane being down, sending, by the first data plane, a request to reestablish communication with the application control plane.

19. The system of claim 15, the actions further comprising:
responsive to the application control plane being down, continuing, by the first data plane, to serve requests for the first microservice based on the cached configuration.

20. The system of claim 15, the actions further comprising:
responsive to receiving, from the application control plane, a configuration update, determining whether the first data plane can enable requested features of the configuration update; and
responsive to determining that the configuration update does not include new features from a newer version at the application control plane, caching the configuration update at the local storage disk.
